(19) United States
(12) Patent Application Publication
(10) Pub. No.: US 2006/0045122 A1
(43) Pub. Date: Mar. 2, 2006

(54) Interaction system

(76) Inventor: Shail Patel, Merseyside (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/517,934

(22) PCT Filed: Apr. 14, 2004
(86) PCT No.: PCT/US04/11464

§ 371 Date: Aug. 22, 2005

(30) Foreign Application Priority Data
Apr. 15, 2003 (EP) 03252373.0

(51) Int. Cl. H04L 12/66

(52) U.S. Cl. 370/463

(57) ABSTRACT

The present invention provides an electronic system for interaction between a specific user and a service provider, comprising: (a) receipt means for obtaining information from the user for establishing a profile of said user; (b) control means for the service provider for providing and displaying one or more system responses to the input provided under (a); (c) means for initialising one or more business rules for each type of system response, said business rules specifying the match between the system response and the related user profile and also the desired outcome in terms of actions to be taken by the user; (d) means for selecting the most appropriate business rule for the user, based on the input given under (a); (e) means for observing the behaviour of the user; and (f) feedback means for updating the business rules based on the difference between the desired outcome and the actual behaviour by the user.

### FIELD OF THE INVENTION

The present invention relates to an interaction system and to a method of efficient interaction between service providers and users, for example for allowing the efficient obtaining of products and/or to ensure that users are offered the products according to their needs. In this connection, a service provider will generally be a supplier of products and/or services, and a user will generally be a potential customer.

### BACKGROUND OF THE INVENTION

Recently, several trends can be observed in the interface between a user and a service provider.

Firstly, the Internet and other electronic means have opened the possibility for so-called electronic shopping. Several of these shopping possibilities are available for example via Amazon.com or Tesco.com. These electronic shopping environments have extensively been described in the prior art. For instance, U.S. Pat. No. 6,064,980 a discloses a recommendation service which uses user profile information and filtering techniques for recommending items to users of a Web site. Furthermore, WO-00/17792 discloses a recommendation service which recommends items to individual users based on a set of items that are known to be of interest to the user, such as items previously purchased by said user.

A problem with these traditional electronic shopping environments is that they are supplier driven systems and do not or only to a limited extent allow the adaptation of offered goods and conditions according to the wishes of the customer.

Secondly so-called e-commerce auction based systems are used more often; these systems allow the user to bid for certain goods. These systems have the advantage that the user can indicate the price he is prepared to offer, after which the supplier can decide whether said price is acceptable for the supplier. Such user driven trading systems are often more preferred by the users.

Thirdly with the rapid development of new media and communication channels, companies are increasingly searching for new methods to provide targeted information relating to their goods to select groups of consumers or to obtain from selected consumers relevant information which may help to develop new products or services. However consumers are increasingly aware of the value of information especially the value of their personal data and opinions.

There is therefore a need to provide improved electronic systems which are capable to provide a personalised, self-adapting and custom interaction process which is efficient and which provides the possibility to the supplier to obtain the desired information and which allows the user to obtain a compensation for this information.

It has now been found that said need can be fulfilled by an improved system for interaction between a specific user and a supplier, involving business rules that specify the match between the user profile and the system response and also the desired outcome in terms of actions to be taken by the customer. Furthermore, said system contains feed back means for updating these business rules based on the comparison between the desired and the observed behaviour by the customer.

### DEFINITION OF THE INVENTION

Accordingly, the invention provides an electronic system for interaction between a specific user and a service provider, comprising:
(a) receipt means for obtaining information from the user for establishing a profile of said user;
(b) control means for the service provider for providing and displaying one or more system responses to the input provided under (a);
(c) means for initialising one or more business rules for each type of system response, said business rules specifying the match between the system response and the user profile, and also the desired outcome in terms of actions to be taken by the user;
(d) means for selecting the most appropriate business rule for the user, based on the input given under (a);
(e) means for observing the behaviour of the user; and
(f) feedback means for updating the business rules based on the difference between the desired outcome and the actual behaviour by the user.

In another aspect, the invention provides a method for improving interaction between a user and a service provider, wherein said method uses a system according to claim 1 and comprises the following steps:
(i) the user electronically provides information for establishing a user profile;
(ii) the system selects the business rule which is most appropriate for the user based on the information given under (a);
(iii) based on this business rule, the appropriate system response is provided and displayed;
(iv) the behaviour of the user is observed and compared with the desired behaviour specified by the business rule; and
(v) based on the comparison between the desired and observed behaviour by the user, the business rule is updated.

The system and method of the present invention will now be described in more detail below.

### DETAILED DESCRIPTION OF THE INVENTION

Systems in accordance with the invention provide an improved way of interaction between a service provider and a user such that the needs of the user are better served. Furthermore, such interaction systems are designed to be personalised systems which are suitable to give each individual user what is best for him.

In this connection, a user of a system of the invention will generally be a potential customer who is looking for information about products and services.

On the other hand such interaction systems also address the business needs of the service provider. Through the availability of questions, such as market research questions, as possible part of the system response to the input provided by the consumer, the service provider obtains a better understanding of the user. Furthermore the system response to the input by the customer can be better matched with the profile of said customer, after said questions have been replied to.

The system of the invention enforces a good design discipline on the designer thereof: each offering needs to have specified the business rule concerned, i.e. the ideal user whom that system response is targeted to.

Furthermore, the interaction system of the invention is not only a personalised system. It is also a self-adaptive and learning system since it contains means for updating the business rules based on the difference between actual observed behaviour and desired behaviour.

For practical reasons, the electronic system of the invention is preferably a computer system or a telecommunication system.

The User Profile

The user profile consists of information about a specific user of the system of the invention. The user profile desirably comprises information selected from the group consisting of purchase behaviour, demographics, habits, attitudes, needs, preferences, certainty factor, psycho-graphics, linguo-graphics, diagnostics and combinations thereof.

The user profile may be mapped into a representative space using dimension reduction techniques such as graphical modelling, and multidimensional scaling. If applied, this mapping should take into account the uncertainty of the data in the user profile and the missing values.

Furthermore, if mapping techniques are applied, then each individual user is a point in a representative mapping space.

The System Responses

When the method of the present invention is being carried out by a user, the system selects the business rule that is most appropriate for the user based on the profile provided by said user, and based on this business rule the appropriate system response is provided.

In general, the system responses are selected from the group consisting of providing information content, offering a marketing lever, asking questions, and combinations thereof.

The information content to be provided as system response, may be any relevant information such as the indication of a Web page, fashion information, a recipe, a description of a product, a comparison between various products or combinations thereof. The information may also contain games and entertainment.

The marketing lever to be offered as system response, is preferably selected from the group consisting of product promotion, a free sample, a free service and combinations thereof. The product promotion will usually include a discount of the price.

The questions raised as part of the system response, may effectively be used for electronic market research purposes.

The Business Rules

The system of the invention comprises one or more business rules for each type of system response. In connection with the present invention, such business rules are designed to be a description of the ‘ideal’ user for whom the specific system response concerned has been designed. In other words, each of the business rules is used for specifying the match between the system response and the related user profile of an actual user who operates the system of the invention.

The business rules also specify the desired outcome in terms of actions to be taken by the user. This desired outcome may include the following actions: reading of the information provided, taking up of the promotion offered, or answering of questions raised.

The desired outcome may also include behaviour of the user at some later date, e.g. the purchase of a product some weeks later when it is no longer on promotion.

When a user operates the system of the invention, said system selects the business rule or rules that are most appropriate of that user, by evaluating the distance between all business rules and the user profile provided by said user.

These one or more business rules are subsequently initiated and the appropriate system response is provided and displayed for the user.

The behaviour by the user is then observed and compared with the user profile concerned, and if needed, the user profile may be suitably updated.

Furthermore, the difference between the desired outcome and the observed behaviour is used for updating the business rules that were initiated. A number of algorithms may be applied for calculating this difference and for carrying out this updating. These new updated business rules may also be suitably analysed for gaining information on changes in user behaviour.

The invention will now be illustrated in the following examples.

### EXAMPLE 1

This example relates to the marketing of Pepsodent toothpaste (with a toothbrush) in rural India, whereby the system of the invention is used.

In India, the so-called “Neem-Stick” is currently generally used for tooth brushing purposes. In the present example, the electronic interaction system of the invention is used for informing potential customers about Pepsodent toothpaste, aiming at higher sales thereof.

The user profile is designed to contain the following items:

(1) Pepsodent usage

(2) Own TV and/or radio, or none

(3) “Neem-Stick” usage

(4)-(6) confidence levels of (1)-(3) above.

4 users have completed this user profile and their resulting specific user profiles are as follows (on a range of 0-1, “0” being fully negative and “1” being fully positive):

| | (1) | (2) | (3) | (4) | (5) | (6) |
|---|---|---|---|---|---|---|
| user (a) | 0 | 0.75 | 0.67 | 1.0 | 0 | 0 |
| user (b) | 0 | 0.75 | 1.00 | 1.0 | 0 | 0 |
| user (c) | 0 | 1.00 | 0.50 | 0 | 1.0 | 1.0 |
| user (d) | 0 | 0.50 | 0.50 | 0 | 1.0 | 1.0 |

It is noted that item (2) is included in the user profile so as to measure the extent of affluence of the users.

The system contains the following response types:

1) Here is a promotion of Pepsodent

2) Here is some information about oral health

3) Here is a film clip to watch

4) Do you use Pepsodent; yes=3, smtms=2, no=1

5) Do you have a TV/radio: TV=3, radio=2, none=1

6) Do you use a “Neem-Stick”: yes=3, smtms=2, no=1

It is noted that “smtms” means ‘sometimes’.

Each response type is assigned three Business Rules as a weighting in the space of the user profile.

The Business Rule (BR) weightings for response types 1)-3) are used for matching purposes with respect to items (1)-(3) in the user profile.

These BR weightings are:

| | (1) | (2) | (3) |
|---|---|---|---|
| i-BR | 0.20 | 0.80 | 0.50 |
| ii-BR | 0.10 | 0.55 | 0.90 |
| iii-BR | 0.50 | 0.20 | 0.50 |

The first user logs on the system.

For this user, it can be seen that the first Business Rule i-BR gives the best match with his user profile.

For this 1^{st} user , the system action includes the offering of a promotion for Pepsodent.

At some later date, the system asks this 1^{st} user the following question so as to observe his behaviour:

Have you now bought Pepsodent full price?; yes=3, smtms=2, no=1.

It is noted that the desired behaviour for the user is to buy Pepsodent full price. The observed behaviour, in this case, is measured by this question. The difference between desired behaviour and actual observed behaviour (to be used in further operation of the system) is calculated based on the table of responses below:

| User's Answer | Interface | Difference in behaviour |
|---|---|---|
| Yes | 3 | 1 |
| Sometimes | 2 | 0 |
| No | 1 | −1 |

The 1^{st} user actually replies “yes”, by clicking on “3”. With this positive response by the 1^{st} user, the first Business Rule weightings are updated by the system, and the resulting values are:

| | (1) | (2) | (3) |
|---|---|---|---|
| i-BR | 0.0916 | 0.7729 | 0.5903 |

For this updating, the following calculations have been carried out.

The Euclidean distance between user (a) and i-BR is the Euclidean distance between

$$[ \begin{matrix}0 & 0.7500 & 0.6667\end{matrix} ] and \\ [ \begin{matrix}0.2000 & 0.8000 & 0.5000\end{matrix} ]$$

which equals 0.2651. This is called ‘Edist’.

Then, lambda is set to be:
5*(Edist+3)ˆ−3=0.1436

Subsequently, the unit vector between user (a) and i-BR is calculated as follows:

$$\begin{matrix}Unit vector = ( user ( a ) - i \text{-} BR ) / Edist ; \\ = [ \begin{matrix}- 0.7544 & - 0.1886 & 0.6287\end{matrix} ] ;\end{matrix}$$

Finally, the new Business Rule is calculated by:

$$\begin{matrix}i \text{-} BR ( new ) = i \text{-} BR + difference in behaviour * lambda * unitvector \\ = [ \begin{matrix}0.0916 & 0.7729 & 0.5903\end{matrix} ]\end{matrix}$$

### EXAMPLE 2

This example describes the situation, wherein the 1^{st} user is known to the system of the invention, since this user has—amongst others—operated the system as described in Example 1. After the 1^{st} user has again logged on to the system, the system reacts by displaying the following:

“Welcome back, user (a), I have some things you may be interested in These include:
a promotion for your favourite Thai cooking sauce;
a preview of a recent song release by one of your favourite artists;
five short questions to answer. In return, we will offer you a free sample of a conditioner, and can provide a better interactive service in future.

User (a) selects the promotion of the Thai cooking sauce and agrees to answer the five questions.

These actions are logged by the system, as are any of the previous and further interactions and actions by user (a). Furthermore, the responses by user (a) to the 5 questions are analysed by the system (i.e. compared with the expected/desired responses), and any relevant business rules are updated, as needed.

Next time that user (a) runs the system of the invention, there will be a new set of offerings depending on the analysis of previous interactions.

1. An electronic system for interaction between a specific user and a service provider, comprising:
(a) receipt means for obtaining information from the user for establishing a user profile of said user;
(b) control means for the service provider for providing and displaying one or more system responses to the input provided under (a);
(c) means for initialising one or more business rules for each type of system response, said business rules specifying the match between the system response and the related user profile and also the desired outcome in terms of actions to be taken by the user;
(d) means for selecting the most appropriate business rule for the user, based on the input given under (a);
(e) means for observing the behaviour of the user; and
(f) feedback means for updating the business rules based on the difference between the desired outcome and the actual behaviour by the user.

2. A system according to claim 1, wherein the user profile mentioned under (a) comprises information about said user selected from the group consisting of purchase behaviour, demographics, habits, attitudes, needs, preferences, certainty factor, psycho-graphics, linguo-graphics, diagnostics and combinations thereof.

3. A system according to claim 1, wherein the system responses mentioned under (b) are selected from the group consisting of providing information content, offering a marketing lever, asking questions, and combinations thereof.

4. A system according to claim 3, wherein the marketing lever is selected from the group consisting of a product promotion, a free sample, a free service and combinations thereof.

5. A system according to claim 1, wherein the desired outcome specified in each business rule includes one or more actions by the user selected from reading of information, taking up of promotions and answering of questions.

6. A system according to claim 1, being an computer system or a telecommunication system.

7. Method for improving interaction between a user and a service provider, wherein said method uses a system according to claim 1 and comprises the following steps:
(i) the user electronically provides information for establishing a user profile;
(ii) the system selects the business rule which is most appropriate for the user based on the information given under (a);
(iii) based on this business rule, the appropriate system response is provided and displayed;
(iv) the behaviour of the user is observed and compared with the desired behaviour specified by the business rule; and
(v) based on the comparison between the desired and observed behaviour by the user, the business rule is updated.

8. Method according to claim 7, wherein the observed behaviour by the user is used to update the user profile.

9. Method according to claim 7, wherein the updated business rule is analysed for gaining information on changes in user behaviour.
